(19) United States
(12) Patent Application Publication
(10) Pub. No.: US 2025/0035826 A1
(43) Pub. Date: Jan. 30, 2025

(54) VARIABLE FOCAL LENGTH LENS DEVICE

(71) Applicant: Mitsubishi Electric Corporation, Tokyo (JP)

(72) Inventor: Kohei SAKAI, Tokyo (JP)

(73) Assignee: Mitsubishi Electric Corporation, Tokyo (JP)

(21) Appl. No.: 18/918,656

(22) Filed: Oct. 17, 2024

Related U.S. Application Data
(63) Continuation of application No. PCT/JP2022/020311, filed on May 16, 2022.

(51) Int. Cl. G02B 3/14; G02B 7/04

(52) U.S. Cl. CPC G02B 3/14; G02B 7/04

(57) ABSTRACT

A variable focus lens device includes: a first variable focus lens; a second variable focus lens disposed behind the first variable focus lens; a third variable focus lens disposed behind the second variable focus lens; a fixed focus lens disposed behind the third variable focus lens; a first conjugate point that is disposed at a first focus before the first variable focus lens; a second conjugate point that is disposed at a fourth focus behind the fixed focus lens; and a third conjugate point that is disposed at a second focus behind the second variable focus lens, and at a third focus before the third variable focus lens, a first partial optical system is an infinite conjugate system in relation to the first conjugate point, and a second partial optical system is an infinite conjugate system in relation to the third conjugate point.

### CROSS REFERENCE TO RELATED APPLICATION

This application is a Continuation of PCT International Application No. PCT/JP2022/020311, filed on May 16, 2022, which is hereby expressly incorporated by reference into the present application.

### TECHNICAL FIELD

The present disclosure relates to a variable focal length lens device.

### BACKGROUND ART

For example, optical technology has been applied to various devices such as machining devices, observation devices, distance measuring devices, and illumination devices. It is required that, in such devices, the magnification and focus position of an optical system be able to be changed freely.

Typically, in order to change the magnification and focus position of an optical system, it is necessary to change, in the direction of the optical axis, the arrangement of optical components such as lenses or an image sensor included in the optical system, or the like. A device configuration based on the assumption that optical components move has many problems in terms of the complexity of designing, the size of the device, the manufacturing cost, the reliability, and the like. In particular, the problems become noticeable in a case of a magnification adjustment mechanism in which it is difficult to cope with a magnification adjustment merely by simply extending an entire lens group or part of a lens group. Still, adjustment of the magnification and focus position of an observation device such as a camera or a microscope is implemented by using a mechanical drive mechanism, but the mechanical drive mechanism further has a problem in terms also of rapid responsiveness, in addition to the problems mentioned above.

On the other hand, variable focal length lens devices that have a variable focal length without including a mechanical drive mechanism have been provided. For example, for this type of variable focal length lens device, liquid lenses using an electrowetting technology have been adopted. The liquid lenses are used as variable focal length lenses. Typically, liquid lenses function as plano-convex lenses or plano-concave lenses. Accordingly, it is desirable if the liquid lenses form an infinite conjugate system in order to reduce aberrations.

Patent Literature 1 discloses a shape measuring device using the variable focal length lenses described above.

### CITATION LIST

### Patent Literature

Patent Literature 1: JP 2016-053491 A

### SUMMARY OF INVENTION

### Technical Problem

The shape measuring device disclosed in Patent Literature 1 includes three variable focal length lenses. Among them, one variable focal length lens disposed on the object side is for changing the focus position. In addition, two variable focal length lenses arranged on the image side are for changing the magnification. The principle of variable magnification is that the ratio between the composite focal length with a finite magnitude of the two variable focal length lenses on the image side according to a formula of composite lenses, and the focal length of the variable focal length lens on the object side is adjusted such that a desired magnification is attained. Using the two variable focal length lenses ensures two degrees of freedom necessary for adjustment of the focal length, and adjustment of the main surface position. On the other hand, in the disclosure, the two variable focal length lenses on the magnification adjustment side form, as one group, an infinite conjugate system. Accordingly, the lens closest to an image is a finite conjugate system if the lenses are seen singly. Accordingly, aberrations occur easily.

The present disclosure has been made to solve the problems described above, and an object thereof is to provide a variable focal length lens device that has a magnification and a focus position that can be changed as desired, which is suitable for variable focal length lenses.

### Solution to Problem

A variable focal length lens device according to the present disclosure includes: a first variable focal length lens that has a first focal length; a second variable focal length lens that is disposed behind the first variable focal length lens, and has a second focal length; a third variable focal length lens that is disposed behind the second variable focal length lens, and has a third focal length; a fixed focal length lens that is disposed behind the third variable focal length lens, and has a fourth focal length; a first conjugate point that is disposed at a distance equal to the first focal length before the first variable focal length lens, and serves as a focus position; a second conjugate point that is disposed at a distance equal to the fourth focal length behind the fixed focal length lens, and is provided with an image sensor or a light guiding device; and a third conjugate point disposed at a distance equal to the second focal length behind the second variable focal length lens, and at a distance equal to the third focal length before the third variable focal length lens, wherein a first partial optical system including the first variable focal length lens and the second variable focal length lens is an infinite conjugate system in relation to the first conjugate point, and a second partial optical system including the third variable focal length lens and the fixed focal length lens is an infinite conjugate system in relation to the third conjugate point.

### Advantageous Effects of Invention

The present disclosure makes it possible to change the magnification and the focus position as desired, which is suitable for variable focal length lenses.

### BRIEF DESCRIPTION OF DRAWINGS

FIGS. 1A and 1B are figures illustrating a configuration of a variable focal length lens device according to a first embodiment.

FIGS. 2A and 2B are figures illustrating another configuration of the variable focal length lens device according to the first embodiment.

FIGS. 3A and 3B are figures illustrating another configuration of the variable focal length lens device according to the first embodiment.

FIGS. 4A and 4B are figures illustrating another configuration of the variable focal length lens device according to the first embodiment.

FIG. 5 is a figure illustrating operation performed by the variable focal length lens device according to the first embodiment.

FIG. 6 is a figure illustrating another operation performed by the variable focal length lens device according to the first embodiment.

FIG. 7 is a figure illustrating another operation performed by the variable focal length lens device according to the first embodiment.

FIG. 8 is a figure illustrating another operation performed by the variable focal length lens device according to the first embodiment.

FIG. 9 is a figure illustrating another operation performed by the variable focal length lens device according to the first embodiment.

FIGS. 10A and 10B are figures illustrating a configuration of a variable focal length lens device according to a second embodiment.

FIGS. 11A and 11B are figures illustrating another configuration of the variable focal length lens device according to the second embodiment.

FIGS. 12A and 12B are figures illustrating a configuration of a variable focal length lens device according to a third embodiment.

FIGS. 13A and 13B are figures illustrating another configuration of the variable focal length lens device according to the third embodiment.

### DESCRIPTION OF EMBODIMENTS

Hereinbelow, modes for implementing the present disclosure are explained with reference to the attached figures in order to explain the present disclosure in more detail.

### First Embodiment

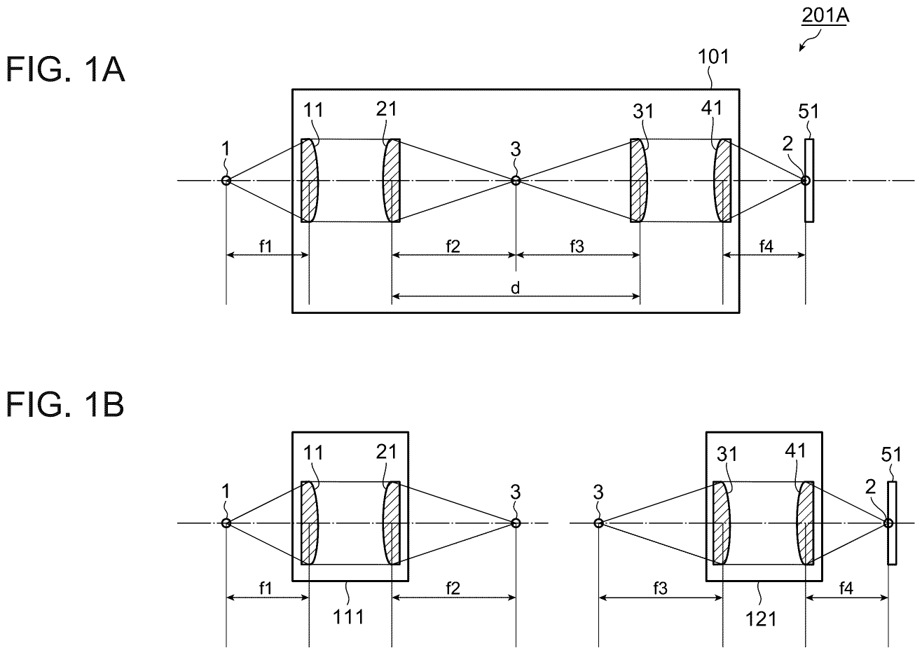

Variable focal length lens devices 201A to 201D according to a first embodiment are explained by using FIGS. 1A and 1B to FIG. 9.

FIGS. 1A and 1B are figures illustrating a configuration of the variable focal length lens device 201A according to the first embodiment. The variable focal length lens device 201A illustrated in FIGS. 1A and 1B includes an optical system 101 and an image sensor 51. Note that, in the variable focal length lens device 201A, a side where the optical system 101 is disposed is referred to as the front side, and a side where the image sensor 51 is disposed is referred to as the rear side.

The optical system 101 has a first variable focal length lens 11, a second variable focal length lens 21, a third variable focal length lens 31, and a fixed focal length lens 41.

The first variable focal length lens 11, the second variable focal length lens 21, the third variable focal length lens 31, and the fixed focal length lens 41 are arranged in this order from the front side toward the rear side. The first variable focal length lens 11, the second variable focal length lens 21, the third variable focal length lens 31, the fixed focal length lens 41, and the image sensor 51 are arranged coaxially, that is, are arranged on the same optical axis.

The first variable focal length lens 11, the second variable focal length lens 21, and the third variable focal length lens 31 are liquid lenses that use liquids as their lens media. By electrically controlling the shapes of the liquids, the radii of curvature of curved surfaces to serve as the lens surfaces or the like change. As a result, the focal lengths of the variable focal length lenses 11, 21, and 31 can be changed.

Specifically, the variable focal length lenses 11, 21, and 31 are formed by sealing the liquids in expandable/contractible resin films. By pressing part of the liquids with piezo actuators, the pressures of the liquids change. As a result, the radii of curvature of the curved surfaces to serve as the lens surfaces of the variable focal length lenses 11, 21, and 31 change, and accordingly the focal lengths can be changed. In addition, electrowetting may be used for the variable focal length lenses 11, 21, and 31. In this case, at the variable focal length lenses 11, 21, and 31, by applying voltage between electrodes with low wettability and droplets thereon, the contact angles of the droplets change. As a result, the focal lengths of the variable focal length lenses 11, 21, and 31 can be changed.

On the other hand, for example, because the radius of curvature of a curved surface to serve as the lens surface of the fixed focal length lens 41 does not change, the focal length is constant. For example, the fixed focal length lens 41 is formed of glass or the like.

The first variable focal length lens 11, the second variable focal length lens 21, the third variable focal length lens 31, and the fixed focal length lens 41 are convex lenses.

The first variable focal length lens 11 has a first focal length f1. The front surface of the first variable focal length lens 11 is a planar surface, and the rear surface of the first variable focal length lens 11 is a convex curved surface. The second variable focal length lens 21 has a second focal length f2. The front surface of the second variable focal length lens 21 is a convex curved surface, and the rear surface of the second variable focal length lens 21 is a planar surface. The third variable focal length lens 31 has a third focal length f3. The front surface of the third variable focal length lens 31 is a planar surface, and the rear surface of the third variable focal length lens 31 is a convex curved surface. The fixed focal length lens 41 has a fourth focal length f4. The front surface of the fixed focal length lens 41 is a convex curved surface, and the rear surface of the fixed focal length lens 41 is a planar surface.

A inter-lens distance d between the second variable focal length lens 21 and the third variable focal length lens 31 is defined by Formula (1) described below.

$$d = f 2 + f 3 \qquad ( 1 )$$

A first conjugate point 1 is set before the first variable focal length lens 11. The first conjugate point 1 is disposed at a distance equal to the first focal length f1 before the first variable focal length lens 11. The first conjugate point 1 is a point where an image-capturing-subject object is disposed, and is a focus position. A second conjugate point 2 is set behind the fixed focal length lens 41. The second conjugate point 2 is disposed at a distance equal to the fourth focal length f4 behind the fixed focal length lens 41. The second conjugate point 2 is a point where the image sensor 51 is disposed.

A third conjugate point 3 is set behind the second variable focal length lens 21. The third conjugate point 3 is disposed at a distance equal to the second focal length f2 behind the second variable focal length lens 21. In addition, as can be understood from Formula (1), the third conjugate point 3 is also a point at a distance equal to the third focal length f3 before the third variable focal length lens 31. In this configuration, at this time, the second variable focal length lens 21 and the third variable focal length lens 31 have the focal lengths f2 and f3 which are both positive lengths. Because of this, the third conjugate point 3 is disposed between the second variable focal length lens 21 and the third variable focal length lens 31.

In the variable focal length lens device 201A, an image of an object disposed at the first conjugate point 1 is formed and captured through the optical system 101 on the image sensor 51 disposed at the second conjugate point 2.

The first variable focal length lens 11 and the second variable focal length lens 21 are included in a first partial optical system 111 that forms an infinite conjugate system in terms of the relationship between the first conjugate point 1 and the third conjugate point 3 (see FIG. 1B). In addition, the third variable focal length lens 31 and the fixed focal length lens 41 are included in a second partial optical system 121 that forms an infinite conjugate system in terms of the relationship between the third conjugate point 3 and the second conjugate point 2 (see FIG. 1B).

Here, the definition of positivity/negativity in the variable focal length lens device 201A is explained. The inter-lens distance d always has a positive value. The focal lengths f1 to f4 have positive values in a case of convex lenses, and have negative values in a case of concave lenses.

As for a way of measuring a position relative to a predetermined position as a reference point, in a case where the position is disposed at a distance equal to a positive focal length before the reference point, this position is defined as being positioned before the reference point. In addition, in a case where the position is disposed at a distance equal to a negative focal length before the reference point, this position is defined as being positioned behind the reference point. In addition, in a case where the position is disposed at a distance equal to the positive focal length behind the reference point, this position is defined as being positioned behind the reference point. Furthermore, in a case where the position is disposed at a distance equal to a negative focal length behind the reference point, this position is defined as being positioned before the reference point.

The overall magnification of the optical system 101 is defined as having a negative value in a case of an inverted image, and as having a positive value in a case of an erect image. In addition, the magnification of an afocal system including the second variable focal length lens 21 and the third variable focal length lens 31 is defined as having a negative magnification in a case where f3/f2>0, and as having a positive magnification in a case where f3/f2<0.

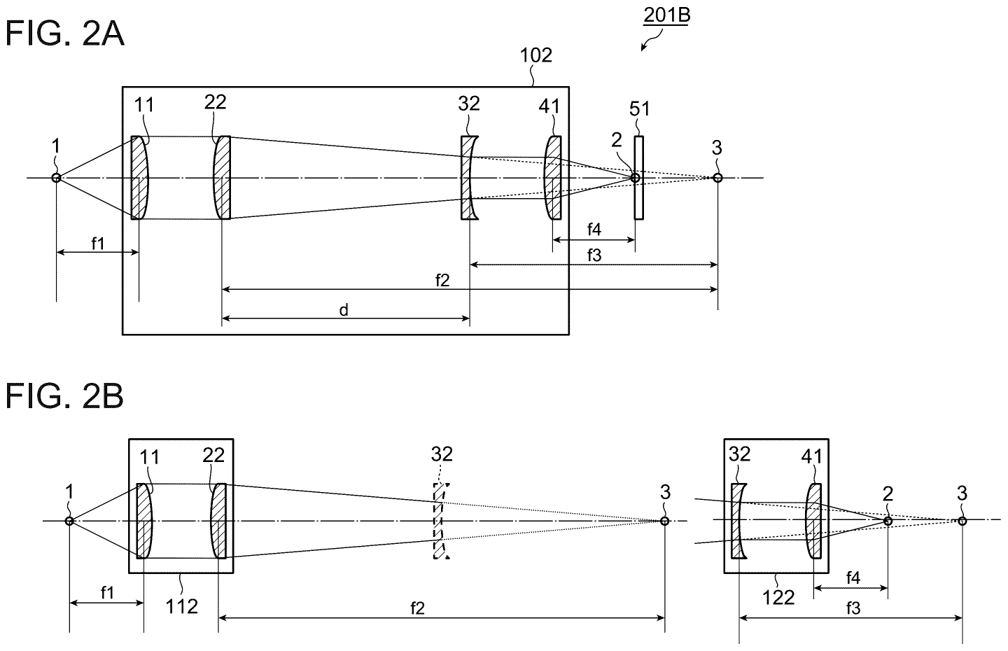

FIGS. 2A and 2B are figures illustrating a configuration of the variable focal length lens device 201B according to the first embodiment. The variable focal length lens device 201B illustrated in FIGS. 2A and 2B is different from the variable focal length lens device 201A in terms of how the second focal length f2 and the third focal length f3 are set. The variable focal length lens device 201B includes an optical system 102 and the image sensor 51.

The optical system 102 has the first variable focal length lens 11, a second variable focal length lens 22, a third variable focal length lens 32, and the fixed focal length lens 41. The first variable focal length lens 11, the second variable focal length lens 22, the third variable focal length lens 32, and the fixed focal length lens 41 are arranged in this order from the front side toward the rear side. The first variable focal length lens 11, the second variable focal length lens 22, the third variable focal length lens 32, and the fixed focal length lens 41 are arranged on the same optical axis.

The second variable focal length lens 22 is a convex lens. The front surface of the second variable focal length lens 22 is a convex curved surface, and the rear surface of the second variable focal length lens 22 is a planar surface. The third variable focal length lens 32 is a concave lens. The front surface of the third variable focal length lens 32 is a planar surface, and the rear surface of the third variable focal length lens 32 is a concave curved surface.

The second variable focal length lens 22 has the positive second focal length f2. The third variable focal length lens 32 has the negative third focal length f3. In a case where the focal lengths f2 and f3 satisfy Formula (1), the third conjugate point 3 is disposed behind the third variable focal length lens 32 when the device is seen as a whole. In other words, relative to the third variable focal length lens 32, the third conjugate point 3 is disposed at a distance equal to the third focal length f3 before the third variable focal length lens 32.

The first variable focal length lens 11 and the second variable focal length lens 22 are included in a first partial optical system 112 that forms an infinite conjugate system in terms of the relationship between the first conjugate point 1 and the third conjugate point 3 (see FIG. 2B). The third variable focal length lens 32 and the fixed focal length lens 41 are included in a second partial optical system 122 that forms an infinite conjugate system in terms of the relationship between the third conjugate point 3 and the second conjugate point 2 (see FIG. 2B).

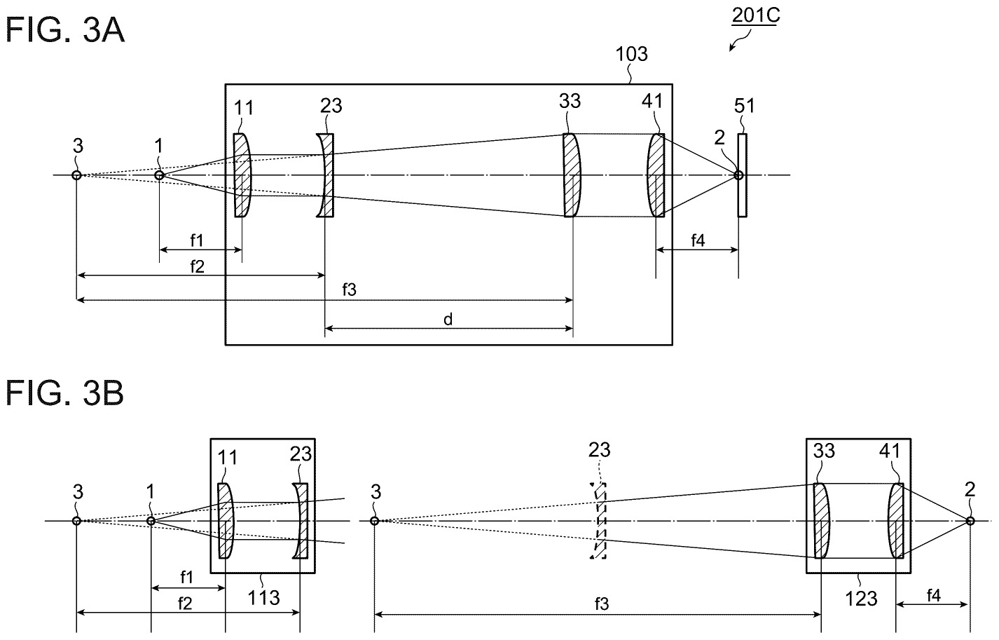

FIGS. 3A and 3B are figures illustrating a configuration of the variable focal length lens device 201C according to the first embodiment. The variable focal length lens device 201C illustrated in FIGS. 3A and 3B is different from the variable focal length lens devices 201A and 201B in terms of how the second focal length f2 and the third focal length f3 are set. The variable focal length lens device 201C includes an optical system 103 and the image sensor 51.

The optical system 103 has the first variable focal length lens 11, a second variable focal length lens 23, a third variable focal length lens 33, and the fixed focal length lens 41. The first variable focal length lens 11, the second variable focal length lens 23, the third variable focal length lens 33, and the fixed focal length lens 41 are arranged in this order from the front side toward the rear side. The first variable focal length lens 11, the second variable focal length lens 23, the third variable focal length lens 33, and the fixed focal length lens 41 are arranged on the same optical axis.

The second variable focal length lens 23 is a concave lens. The front surface of the second variable focal length lens 23 is a concave curved surface, and the rear surface of the second variable focal length lens 23 is a planar surface. The third variable focal length lens 33 is a convex lens. The front surface of the third variable focal length lens 33 is a planar surface, and the rear surface of the third variable focal length lens 33 is a convex curved surface.

The second variable focal length lens 23 has the negative second focal length f2. The third variable focal length lens 33 has the positive third focal length f3. In a case where the focal lengths f2 and f3 satisfy Formula (1), the third conjugate point 3 is disposed before the second variable focal length lens 23 when the device is seen as a whole. In other words, relative to the second variable focal length lens 23, the third conjugate point 3 is disposed at a distance equal to the second focal length f2 behind the second variable focal length lens 23.

The first variable focal length lens 11 and the second variable focal length lens 23 are included in a first partial optical system 113 that forms an infinite conjugate system in terms of the relationship between the first conjugate point 1 and the third conjugate point 3 (see FIG. 3B). The third variable focal length lens 33 and the fixed focal length lens 41 are included in a second partial optical system 123 that forms an infinite conjugate system in terms of the relationship between the third conjugate point 3 and the second conjugate point 2 (see FIG. 3B).

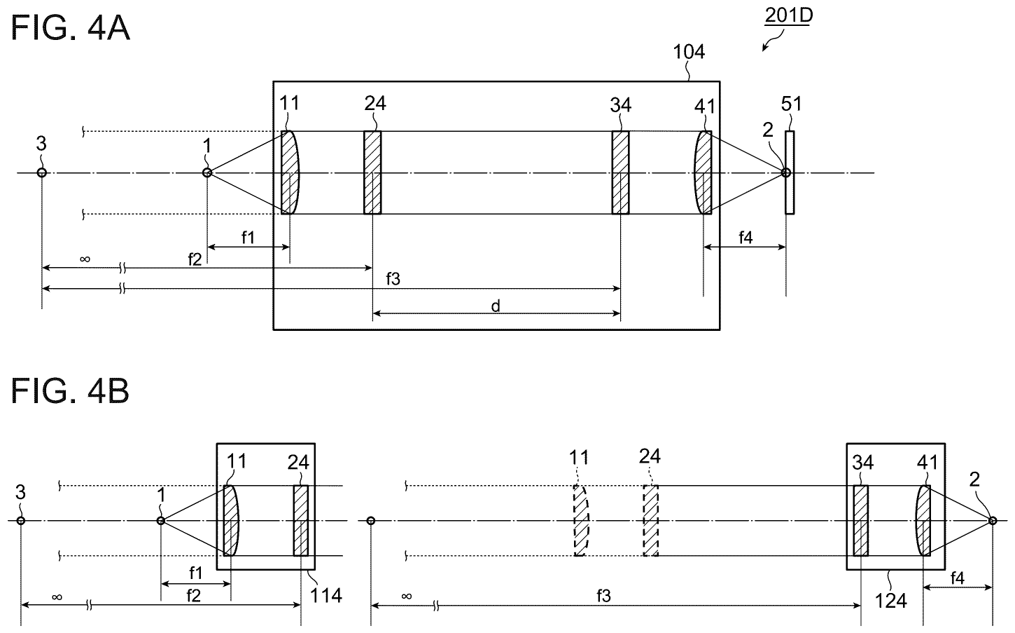

FIGS. 4A and 4B are figures illustrating a configuration of the variable focal length lens device 201D according to the first embodiment. The variable focal length lens device 201D illustrated in FIGS. 4A and 4B is different from the variable focal length lens devices 201A to 201C in terms of how the second focal length f2 and the third focal length f3 are set. The variable focal length lens device 201D includes an optical system 104 and the image sensor 51.

The optical system 104 has the first variable focal length lens 11, a second variable focal length lens 24, a third variable focal length lens 34, and the fixed focal length lens 41. The first variable focal length lens 11, the second variable focal length lens 24, the third variable focal length lens 34, and the fixed focal length lens 41 are arranged in this order from the front side toward the rear side. The first variable focal length lens 11, the second variable focal length lens 24, the third variable focal length lens 34, and the fixed focal length lens 41 are arranged on the same optical axis.

The second variable focal length lens 24 and the third variable focal length lens 34 are tabular planar surface lenses. The front surface and rear surface of the second variable focal length lens 24 are planar surfaces. The front surface and rear surface of the third variable focal length lens 34 are planar surfaces.

The second variable focal length lens 24 has the second focal length f2 having a negative infinite value. The third variable focal length lens 34 has the third focal length f3 having a positive infinite value. The focal lengths f2 and f3 substantially satisfy Formula (1), and the third conjugate point 3 is disposed at an infinite distance before the second variable focal length lens 24 when the device is seen as a whole. In other words, relative to the second variable focal length lens 24, the third conjugate point 3 is disposed at a distance equal to the second focal length f2 behind the second variable focal length lens 24. Since the focal lengths f2 and f3 are infinite in the variable focal length lens device 201D, the second variable focal length lens 24 and the third variable focal length lens 34 function as parallel planar plates with parallel front surfaces and rear surfaces.

The first variable focal length lens 11 and the second variable focal length lens 24 are included in a first partial optical system 114 that forms an infinite conjugate system in terms of the relationship between the first conjugate point 1 and the third conjugate point 3 (see FIG. 4B). The third variable focal length lens 34 and the fixed focal length lens 41 are included in a second partial optical system 124 that forms an infinite conjugate system in terms of the relationship between the third conjugate point 3 and the second conjugate point 2.

Note that, although not illustrated, the optical system 104 may be configured in such a manner that the second variable focal length lens 24 has the second focal length f2 having a positive infinite value, and the third variable focal length lens 34 has the third focal length f3 having a negative infinite value. In this case, the third conjugate point 3 is disposed at an infinite distance behind the third variable focal length lens 34 when the device is seen as a whole. In other words, relative to the third variable focal length lens 34, the third conjugate point 3 is disposed at a distance equal to the third focal length f3 before the third variable focal length lens 34.

In addition, the variable focal length lens devices 201A to 201D are devices to measure images of objects, and include typical image processing devices and illumination devices. In a case where the variable focal length lens devices 201A to 201D include illumination devices, both a configuration in which the illumination devices share part of the optical systems 101 to 104 and a configuration in which the illumination devices do not share part of the optical systems 101 to 104 are possible. In addition, in a case where the illumination devices share part of the optical systems 101 to 104, a configuration in which beam splitters are arranged between the first variable focal length lens 11 and the second variable focal length lenses 21 to 24, and light from the first variable focal length lens 11 and light from the second variable focal length lenses 21 to 24 are multiplexed coaxially, a configuration in which beam splitters are arranged between the first variable focal length lens 11 and the second variable focal length lenses 21 to 24, and light from the first variable focal length lens 11 and light from the second variable focal length lenses 21 to 24 are multiplexed coaxially, and the like are possible.

In addition, in a case where liquid lenses are used as the variable focal length lenses, power supplies or control sections which are not illustrated such as drivers boards to drive the liquid lenses are included.

Next, operation performed by the variable focal length lens device 201A is representatively explained by using FIGS. 1A and 1B. The variable focal length lens device 201A has a magnification and a focus position that can be changed as desired.

First, a case where the variable focal length lens device 201A adjusts the focus position is explained.

As for the first variable focal length lens 11, the variable focal length lens device 201A adjusts the first focal length f1 in such a manner that the distance between the first variable focal length lens 11 and an object that is desired to measure, and the first focal length f1 match. The focus position adjustment of the variable focal length lens device 201A is completed when the distance and the first focal length f1 match in this manner.

Next, a case where the variable focal length lens device 201A changes the magnification is explained.

The second focal length f2 and the third focal length f3 are restricted by the inter-lens distance d as shown in Formula (1). In contrast, Formula (2) described below is a generally-known formula for determining the focal length of composite lenses. In a case where composite lenses satisfy Formula (1), in Formula (2), the focal length of the composite lenses is infinite, and is not defined.

$${f}^{*} = f 2 \times f 3 / ( f 2 + f 3 - d ) \qquad ( 2 )$$

Therefore, the condition represented by Formula (1) is that the system is an afocal system that performs expansion or reduction of a luminous flux. At this time, for example, the magnification m of the optical system 101 is determined by using Formula (3) described below.

$$m = f 2 / f 1 \times f 4 / f 3 \qquad ( 3 )$$

Here, for convenience, an afocal system magnification m* is defined by Formula (4) described below, separately from the magnification m of the optical system 101.

$${m}^{*} = f 3 / f 2 \qquad ( 4 )$$

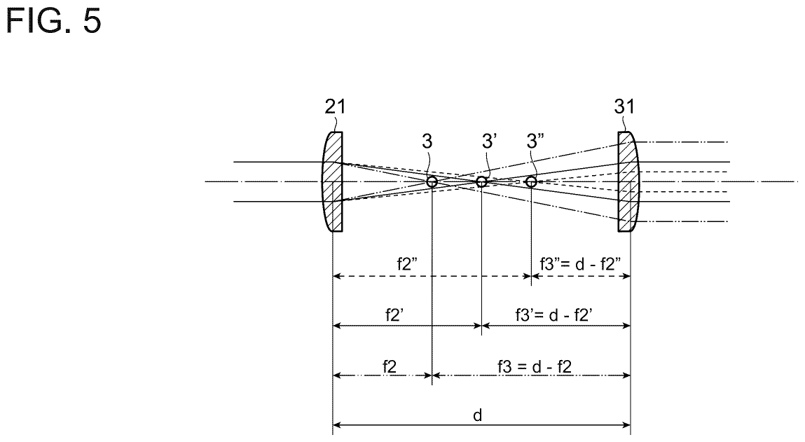

FIG. 5 is a figure illustrating operation performed by an afocal system including the second variable focal length lens 21 and the third variable focal length lens 31. FIG. 5 illustrates three types of operation as examples.

In each operational state, the second variable focal length lens 21 and the third variable focal length lens 31 are adjusted to have a different focal length while satisfying Formula (1). The variable focal length lens device 201A varies the position of the third conjugate point 3 on the basis of mutually different operating conditions, and has third conjugate points 3, 3′, and 3″, for example.

In a case where the variable focal length lens device 201A has the third conjugate point 3, the afocal system magnification m* is “2.” Because of this, the ratio of a luminous flux behind the third variable focal length lens 31 to a luminous flux before the second variable focal length lens 21 is 2.

In a case where the variable focal length lens device 201A has the third conjugate point 3′, the afocal system magnification m* is “1.” Because of this, the ratio of the luminous flux behind the third variable focal length lens 31 to the luminous flux before the second variable focal length lens 21 is 1.

In a case where the variable focal length lens device 201A has the third conjugate point 3″, the afocal system magnification m* is “½.” Because of this, the ratio of the luminous flux behind the third variable focal length lens 31 to the luminous flux before the second variable focal length lens 21 is ½.

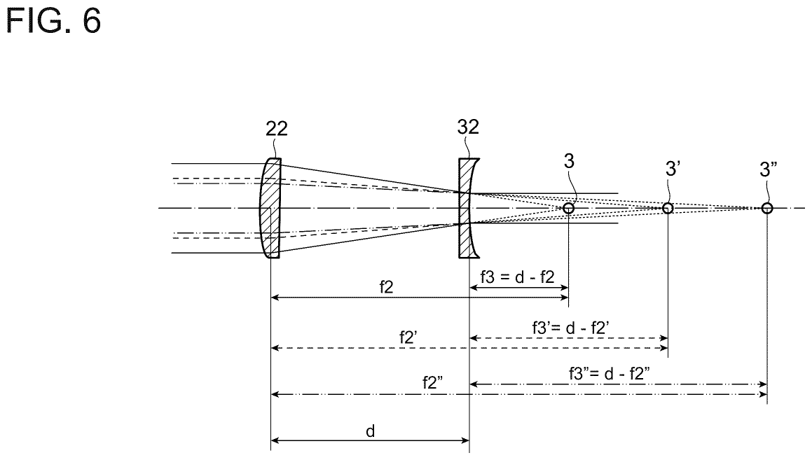

FIG. 6 is a figure illustrating operation performed by an afocal system including the second variable focal length lens 22 and the third variable focal length lens 32. FIG. 6 illustrates three types of operation as examples.

In each operational state, the second variable focal length lens 22 and the third variable focal length lens 32 are adjusted to have different focal lengths while satisfying Formula (1). The variable focal length lens device 201B varies the position of the third conjugate point 3 on the basis of mutually different operating conditions, and has the third conjugate points 3, 3′, and 3″, for example.

In a case where the variable focal length lens device 201B has the third conjugate point 3, the afocal system magnification m* is “⅓.” Because of this, the ratio of a luminous flux behind the third variable focal length lens 32 to a luminous flux before the second variable focal length lens 22 is ⅓.

In a case where the variable focal length lens device 201B has the third conjugate point 3′, the afocal system magnification m* is “½.” Because of this, the ratio of the luminous flux behind the third variable focal length lens 31 to the luminous flux before the second variable focal length lens 21 is ½.

In a case where the variable focal length lens device 201B has the third conjugate point 3″, the afocal system magnification m* is “⅗.” Because of this, the ratio of the luminous flux behind the third variable focal length lens 31 to the luminous flux before the second variable focal length lens 21 is ⅗.

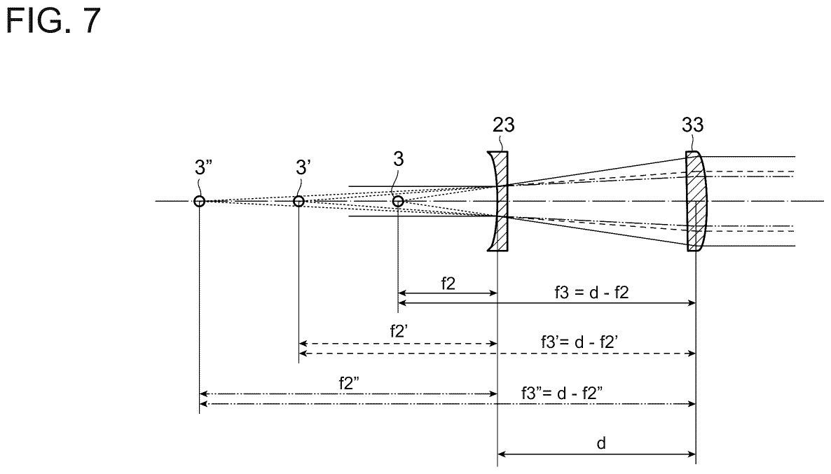

FIG. 7 is a figure illustrating operation performed by an afocal system including the second variable focal length lens 23 and the third variable focal length lens 33. FIG. 7 illustrates three types of operation as examples.

In each operational state, the second variable focal length lens 22 and the third variable focal length lens 32 are adjusted to have different focal lengths while satisfying Formula (1). The variable focal length lens device 201C varies the position of the third conjugate point 3 on the basis of mutually different operating conditions, and has the third conjugate points 3, 3′, and 3″, for example.

In a case where the variable focal length lens device 201C has the third conjugate point 3, the afocal system magnification m* is “3.” Because of this, the ratio of a luminous flux behind the third variable focal length lens 33 to a luminous flux before the second variable focal length lens 23 is 3.

In a case where the variable focal length lens device 201C has the third conjugate point 3′, the afocal system magnification m* is “2.” Because of this, the ratio of the luminous flux behind the third variable focal length lens 33 to the luminous flux before the second variable focal length lens 23 is 2.

In a case where the variable focal length lens device 201C has the third conjugate point 3″, the afocal system magnification m* is “5/3.” Because of this, the ratio of the luminous flux behind the third variable focal length lens 33 to the luminous flux before the second variable focal length lens 23 is 5/3.

Therefore, it can be understood that, in the variable focal length lens devices 201A to 201C, the afocal system magnification m* is adjusted in order to reduce variations of the magnification m while adjusting the focus position by changing the first focal length f1.

By assigning Formulae (2) and (3) to Formula (4) and organizing Formula (4), the afocal system magnification m* can be represented by Formula (5) described below by using the magnification m of the optical system 101, the first focal length f1, and the fourth focal length f4.

$${m}^{*} = f 4 / ( m \times f 1 ) \qquad ( 5 )$$

In addition, by organizing Formula (1) and Formula (3), the second focal length f2 can be represented by Formula (6) described below, and the third focal length f3 can be represented by Formula (7) described below.

$$f 2 = d \times m \times f 1 / ( m \times f 1 + f 4 ) \qquad ( 6 )$$

$$f 3 = d \times f 4 / ( m \times f 1 + f 4 ) \qquad ( 7 )$$

Accordingly, an image of an object disposed at the first conjugate point 1 is formed at the image sensor 51 after being corrected to a certain optical system magnification by the second variable focal length lenses 21 to 23 and the third variable focal length lenses 31 to 33. In addition, when the first focal length f1 is changed, and the position of the first conjugate point 1 is adjusted to a position different from the position where the object is disposed, furthermore, in that state, an image of the object is formed at the image sensor 51 after being corrected to a certain optical system magnification by the second variable focal length lenses 21 to 23 and the third variable focal length lenses 31 to 33.

Here, operation performed by the variable focal length lens devices 201A to 201C is explained by using specific values in order to further facilitate understanding.

For example, it is assumed that the magnification m is “1,” and the focus position (the first conjugate point 1) is changed between 50 mm and 150 mm. In addition, it is assumed that the inter-lens distance d between the second variable focal length lenses 21 to 23 and the third variable focal length lenses 31 to 33 is 200 mm.

Only cases where the first focal length f1 is 50 mm and 150 mm are representatively mentioned as examples. In a case where the first focal length f1 is 50 mm, the second focal length f2 is 100 mm, the third focal length f3 is 100 mm, and the fourth focal length f4 is 50 mm. In addition, in a case where the first focal length f1 is 150 mm, the second focal length f2 is 150 mm, the third focal length f3 is 50 mm, and the fourth focal length f4 is 50 mm. Then, as the first focal length f1 is changed from 50 mm to 150 mm, the second focal length f2 is adjusted from 100 mm to 150 mm according to Formula (6). In addition, the third focal length f3 is adjusted from 100 mm to 50 mm according to Formula (7).

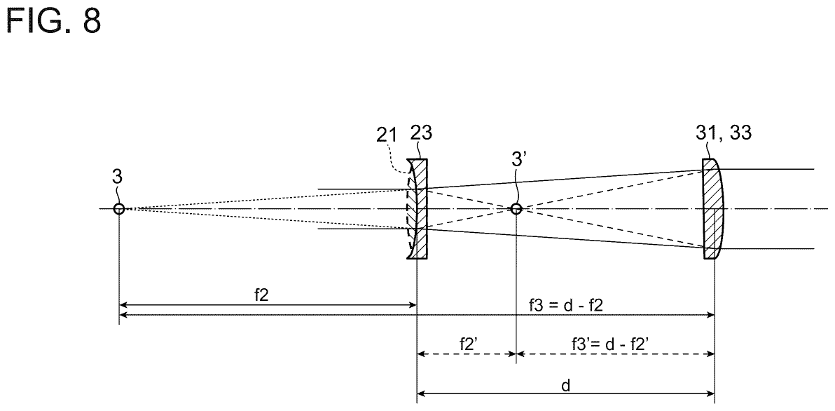

FIG. 8 is a figure illustrating operation performed by afocal systems including the second variable focal length lenses 21 and 23 and the third variable focal length lenses 31 and 33.

It can be known that since the magnification m of the optical systems 101 to 103 can either be positive or negative, there are two operation modes with identical absolute values of the magnification m in Formula (5), Formula (6), and Formula (7). The two operation modes correspond to the magnification reduction operating conditions illustrated in FIGS. 5 and 6, or the magnification expansion operating conditions illustrated in FIGS. 5 and 7. In addition, the two operation modes correspond to a difference as to whether the afocal system magnification m* has positive or negative values with equal absolute values.

FIG. 8 illustrates an example depicting two operation modes in a case where absolute values of the afocal system magnification m* are 2. In an operation mode in which the afocal system magnification m* is 2, the second variable focal length lens 23 and the third variable focal length lens 33 satisfy Formula (1) and Formula (4). On the other hand, in an operation mode in which the afocal system magnification m* is −2, the second variable focal length lens 21 and the third variable focal length lens 31 satisfy Formula (1) and Formula (4). In the two operation modes described above, the position of the third conjugate point 3 varies, and positions after the variations are illustrated as the third conjugate points 3 and 3′. The sign of the optical system magnification is inverted when the two operation modes are switched from one to the other, and accordingly this provides an advantageous effect that a captured image to be acquired is freely inverted.

Furthermore, the following explains that the two operation modes described above are suitable particularly in a case where the variable focal length lenses which are liquid lenses are adopted.

Varying degrees of characteristics deterioration of posture dependence due to the gravity or the like have been reported about liquid lenses. At this time, in planar optical arrangement in which an optical axis is disposed perpendicularly to the direction of gravity, the upper side (opposite to the ground) of a lens and the lower side (the ground side) of the lens have different aberration characteristics in some cases. It is difficult to correct such an asymmetric aberration about the optical axis, but, by making use of the two operation modes described above, it becomes possible to digitally correct the asymmetric aberration.

That is, in a case where the afocal system magnification m* is positive, rays of light having passed through the lower sides of the second variable focal length lenses 21 to 23 pass through the lower sides of the third variable focal length lenses 31 to 33. At this time, aberrations according to the postures occur similarly both at a pair of variable focal length lenses. In contrast, in a case where the afocal system magnification m* is negative, rays of light having passed through the lower sides of the second variable focal length lenses 21 to 23 pass through the upper sides of the third variable focal length lenses 31 to 33. At this time, aberrations according to the postures are averaged by a pair of variable focal length lenses. Then, due to the difference between characteristics of a captured image in a case where the afocal system magnification m* is positive and characteristics of a captured image in a case where the afocal system magnification m* is negative, aberrations according to the postures appear as the difference therebetween. Because of this, the aberrations according to the postures can be reduced by digital image correction of the difference described above.

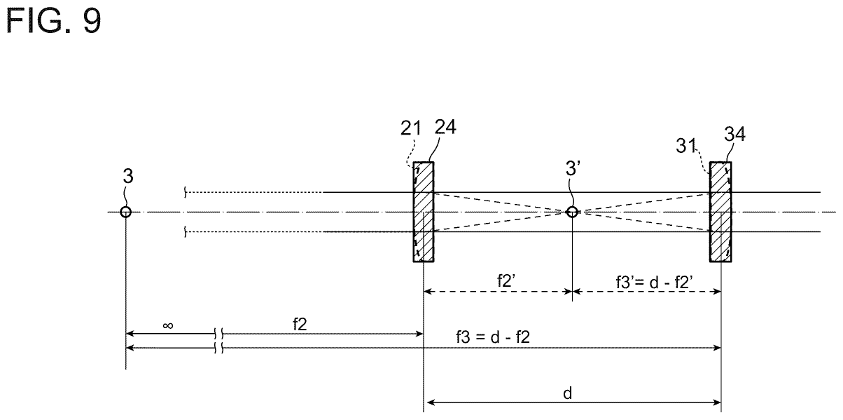

FIG. 9 is a figure illustrating operation performed by afocal systems including the second variable focal length lenses 21 and 24 and the third variable focal length lenses 31 and 34. FIG. 9 illustrates a special example of the two operation modes in which absolute values of the magnification m become identical values illustrated in FIG. 8, and shows an example depicting the two operation modes in a case where the absolute values of the magnification m are 1.

In an operation mode in which the afocal system magnification m* is 1, both the second variable focal length lens 24 and the third variable focal length lens 34 are parallel planar plates, and these substantially satisfy Formula (1) and Formula (4). In an operation mode in which the afocal system magnification m* is −1, the second variable focal length lens 21 and the third variable focal length lens 31 satisfy Formula (1) and Formula (4). In the two operation modes described above, the position of the third conjugate point 3 varies, and positions after the variations are illustrated as the third conjugate points 3 and 3′. The sign of the optical system magnification is inverted when the two operation modes are switched from one to the other, and accordingly this provides an advantageous effect that a captured image to be acquired is freely inverted.

Note that, strictly speaking, focal length infinity is impossible in terms of manufacturing, and accordingly it is obvious that, in practical operation performed by a variable focal length lens, a condition under which the refractive power, which is the reciprocal of the focal length, becomes 0 within the range of variability is allowed to be regarded as focal length infinity.

As explained thus far, the variable focal length lens devices 201A to 201D according to the first embodiment include: the first variable focal length lens 11 that has the first focal length f1; the second variable focal length lenses 21 to 24 that are arranged behind the first variable focal length lens 11, and have the second focal length f2; the third variable focal length lenses 31 to 34 that are arranged behind the second variable focal length lenses 21 to 24, and have the third focal length f3; the fixed focal length lens 41 that is disposed behind the third variable focal length lenses 31 to 34, and has the fourth focal length f4; the first conjugate point 1 that is disposed at a distance equal to the first focal length f1 before the first variable focal length lens 11, and serves as a focus position; the second conjugate point 2 that is disposed at a distance equal to the fourth focal length f4 behind the fixed focal length lens 41, and is provided with the image sensor 51; and the third conjugate point 3 that is disposed at a distance equal to the second focal length f2 behind the second variable focal length lenses 21 to 24, and at a distance equal to the third focal length f3 before the third variable focal length lenses 31 to 34, the first partial optical systems 111 to 114 including the first variable focal length lens 11 and the second variable focal length lenses 21 to 24 are infinite conjugate systems in relation to the first conjugate point 1, and the second partial optical systems 121 to 124 including the third variable focal length lenses 31 to 34 and the fixed focal length lens 41 are infinite conjugate systems in relation to the third conjugate point 3. Because of this, the variable focal length lens devices 201A to 201D make it possible to change the magnifications and the focus positions as desired, which is suitable for variable focal length lenses.

Note that whereas, as principles of liquid lenses mentioned as specific examples of the variable focal length lenses, one that uses a piezo actuator and one that uses electrowetting are explained, it is obvious that there are no problems in achieving advantageous effects of the invention even if liquid lenses based on other principles are used. In addition, even if lenses that have focal length variable functions other than liquid lenses are used, advantageous effects of the invention can be achieved similarly.

The liquid lenses that are explained as the variable focal length lenses may also have optical functions like solid lenses such as glasses or cover glasses, in addition to portions having liquid lens functions.

As for focal point adjustment mechanisms of the variable focal length lenses, for example, in a case where liquid lenses are used as the variable focal length lenses, the liquid lenses are controlled by electrical physical quantities such as voltage applied to the liquid lenses.

Whereas it is explained that the shapes of the variable focal length lenses and the fixed focal length lens are plano convex shapes, plano concave shapes or tabular shapes, each of them does not have to have a planar portion in a strict sense. It is obvious that there are no problems in achieving advantageous effects of the invention even if each of the lenses has a gentle curvature on the side of a planar surface as in a meniscus lens or a so-called best form lens suitable for an infinite conjugate system.

Whereas there are three operating points in operation performed by an afocal system in the cases explained in the present first embodiment, it is obvious that operating points are not limited to the three operating points. For example, in a case where liquid lenses are used as the variable focal length lenses, the range and resolution of voltage that can be applied to the liquid lenses determine the number of possible operating points.

### Second Embodiment

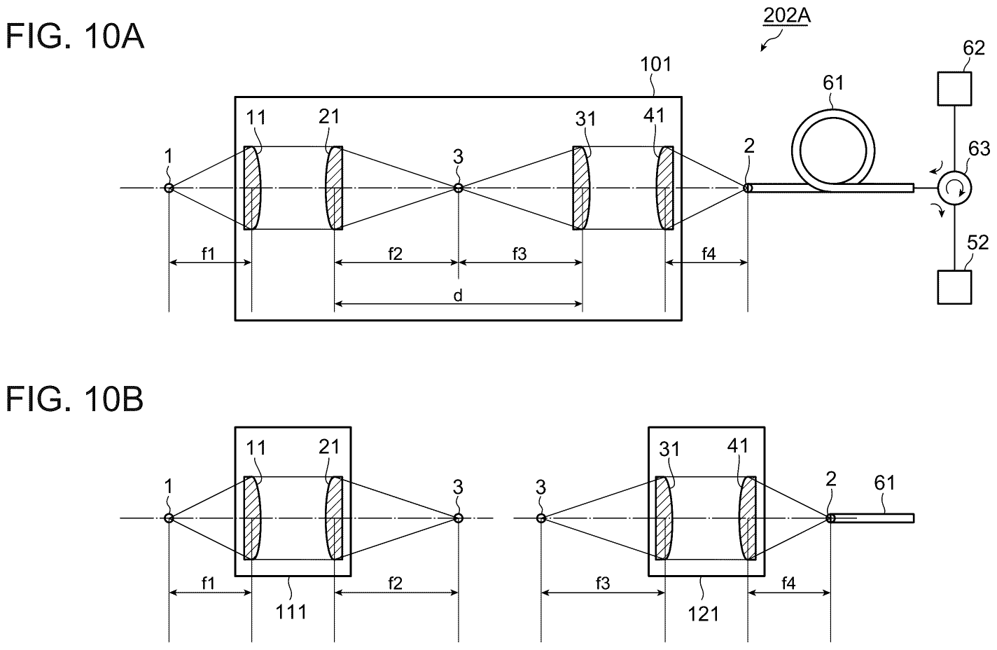

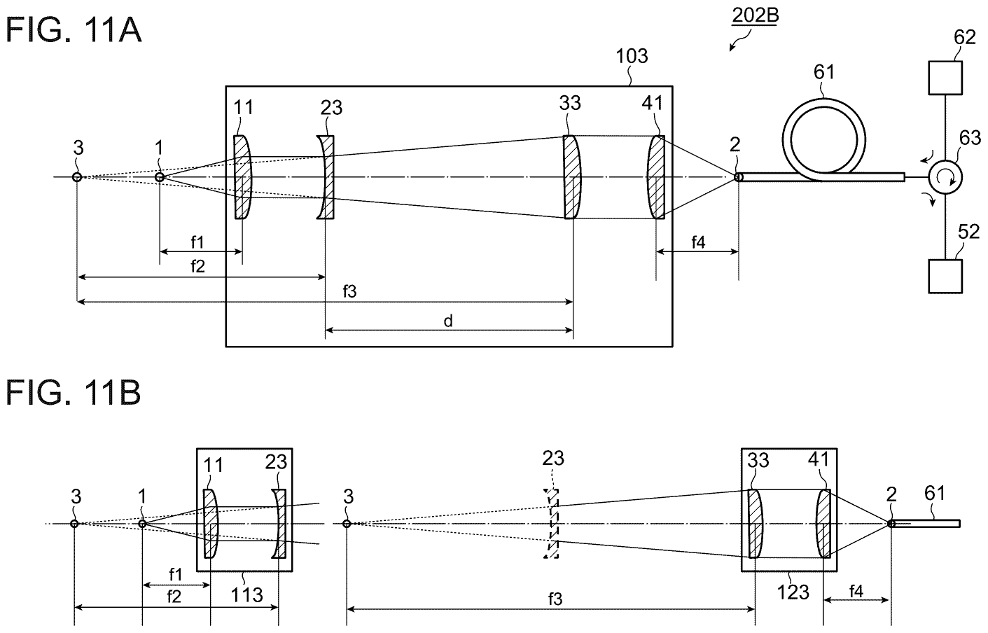

Variable focal length lens devices 202A and 202B according to a second embodiment are explained by using FIGS. 10A and 10B and FIGS. 11A and 11B. Note that components having functions similar to components explained in the first embodiment mentioned above are given identical reference signs, and explanations thereof are omitted.

FIGS. 10A and 10B are figures illustrating a configuration of the variable focal length lens device 202A according to the second embodiment. The variable focal length lens device 202A illustrated in FIGS. 10A and 10B has a configuration in which, instead of the image sensor 51, an optical fiber 61 is disposed at the position of a third conjugate point 3 where an image of a first conjugate point 1 is formed.

Specifically, the variable focal length lens device 202A includes, instead of the image sensor 51 of the variable focal length lens device 201A, a light receiving element 52, the optical fiber 61, an illumination light source 62, and a circulator 63. The optical fiber 61 forms a light guiding means. The circulator 63 forms an optical path splitter.

One end of the optical fiber 61 forms the third conjugate point 3. The other end of the optical fiber 61 is connected with the circulator 63. For example, the optical fiber 61 is a single optical fiber or an optical fiber formed by putting together a plurality of optical fibers into a bundle. The circulator 63 has two ports. One port is optically connected to the illumination light source 62. The other port is optically connected to the light receiving element 52. For example, as an optical connection method, a space optical system, a fiber optical system, or the like is used.

Next, operation performed by the variable focal length lens device 202A is explained. Operation performed by an optical system 101 of the variable focal length lens device 202A to adjust the focus position is the same as operation performed by the optical system 101 of the variable focal length lens device 201A to adjust the focus position. In addition, operation performed by the optical system 101 of the variable focal length lens device 202A to change the magnification m is the same as operation performed by the optical system 101 of the variable focal length lens device 201A to change the magnification m.

Illumination light emitted from the illumination light source 62 passes through the optical fiber 61 and the optical system 101 in this order due to an action of the circulator 63. Then, illumination light having passed through the optical system 101 is emitted to an object disposed at the first conjugate point 1. In contrast, illumination light reflected and scattered by the object passes through the optical system 101 and the optical fiber 61 in this order. Then, illumination light having passed through the optical fiber 61 is incident on the light receiving element 52 due to an action of the circulator 63. As a result, the variable focal length lens device 202A can obtain a captured image of the object from the light receiving element 52 that has received the illumination light.

Accordingly, an image of the object disposed at the first conjugate point 1 is formed at the light receiving element 52 after being corrected to a certain optical system magnification by the second variable focal length lens 21 and the third variable focal length lens 31. In addition, when a first focal length f1 is changed, and the position of the first conjugate point 1 is adjusted to a position different from the position where the object is disposed, furthermore, in that state, an image of the object is formed at the light receiving element 52 after being corrected to a certain optical system magnification by the second variable focal length lens 21 and the third variable focal length lens 31.

Note that whereas the variable focal length lens device 202A illustrated in FIGS. 10A and 10B includes the optical system 101, it may include the optical system 103 as illustrated in FIGS. 11A and 11B instead of the optical system 101. FIGS. 11A and 11B are figures illustrating configuration of the variable focal length lens device 202B according to the second embodiment. The variable focal length lens device 202B includes the optical system 103, the light receiving element 52, the optical fiber 61, the illumination light source 62, and the circulator 63. In addition, whereas the variable focal length lens device 202A includes the optical system 101, it may include the optical system 102 illustrated in FIGS. 2A and 2B or the optical system 104 illustrated in FIGS. 4A and 4B instead of the optical system 101.

As explained thus far, the variable focal length lens devices 202A and 202B according to the second embodiment include: a first variable focal length lens 11 that has the first focal length f1; second variable focal length lenses 21 and 23 that are arranged behind the first variable focal length lens 11, and have a second focal length f2; third variable focal length lenses 31 and 33 that are arranged behind the second variable focal length lenses 21 and 23, and have a third focal length f3; a fixed focal length lens 41 that is disposed behind the third variable focal length lenses 31 and 33, and has a fourth focal length f4; the first conjugate point 1 that is disposed at a distance equal to the first focal length f1 before the first variable focal length lens 11, and serves as a focus position; a second conjugate point 2 that is disposed at a distance equal to the fourth focal length f4 behind the fixed focal length lens 41, and is provided with the optical fiber 61; and the third conjugate point 3 that is disposed at a distance equal to the second focal length f2 behind the second variable focal length lenses 21 and 23, and at a distance equal to the third focal length f3 before the third variable focal length lenses 31 and 33, the first partial optical systems 111 and 113 including the first variable focal length lens 11 and the second variable focal length lenses 21 and 23 are infinite conjugate systems in relation to the first conjugate point 1, and the second partial optical systems 121 and 123 including the third variable focal length lenses 31 and 33 and the fixed focal length lens 41 are infinite conjugate systems in relation to the third conjugate point 3. Because of this, the variable focal length lens devices 202A and 202B make it possible to change the magnifications and the focus positions as desired, which is suitable for variable focal length lenses.

### Third Embodiment

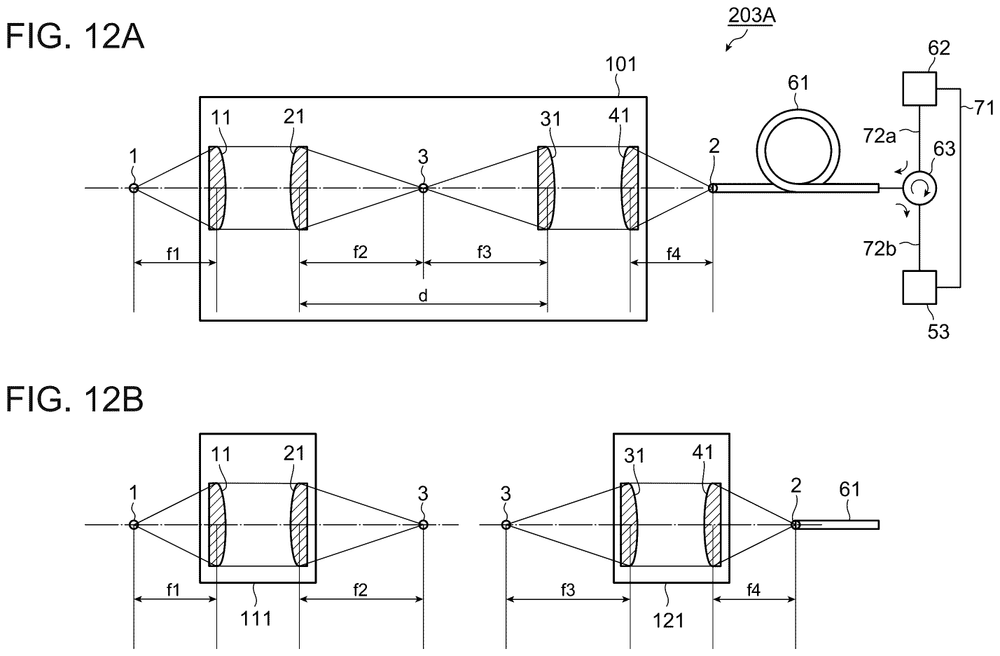

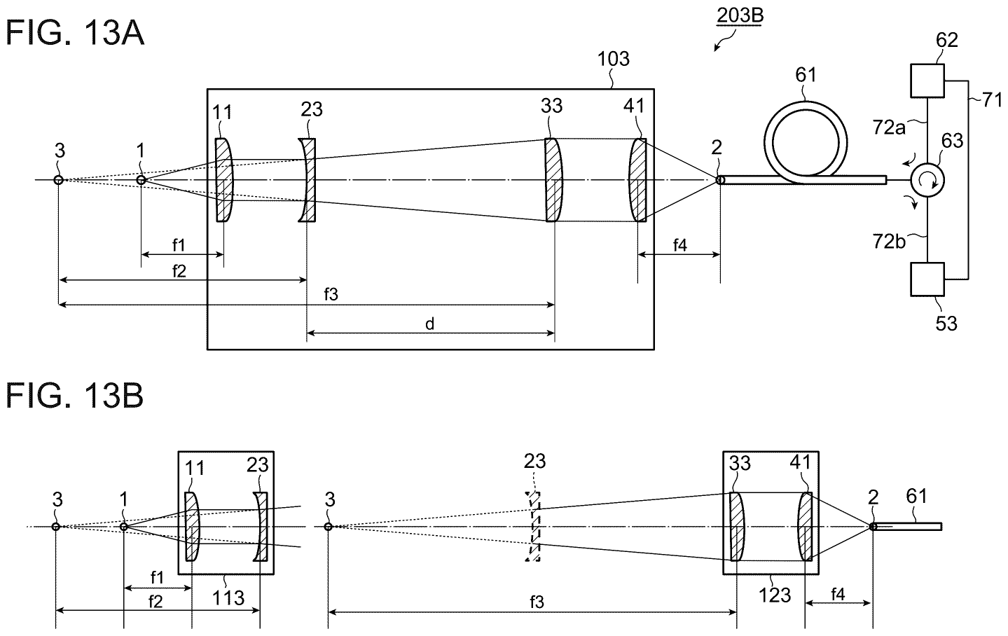

Variable focal length lens devices 203A and 203B according to a third embodiment are explained by using FIGS. 12A and 12B and FIGS. 13A and 13B. Note that components having functions similar to components explained in the first embodiment mentioned above are given identical reference signs, and explanations thereof are omitted.

FIGS. 12A and 12B are figures illustrating a configuration of the variable focal length lens device 203A according to the third embodiment. The variable focal length lens device 203A illustrated in FIGS. 12A and 12B has a configuration in which, after illumination light emitted from an illumination light source 62 is split to a reference optical path 71 and a signal optical path 72a, beams of illumination light obtained after the splitting are multiplexed at a light receiving element 53, thereby making it possible to acquire an interference signal of the beams of the light. That is, the variable focal length lens device 203A has a configuration in which the reference optical path 71 and the signal optical paths 72a and 72b are added to the variable focal length lens device 202A described above.

The reference optical path 71 optically connects the illumination light source 62 and the light receiving element 53. The signal optical path 72a optically connects the illumination light source 62 and one port of a circulator 63. The signal optical path 72b optically connects the other port of the circulator 63 and the light receiving element 53.

Next, operation performed by the variable focal length lens device 203A is explained. Operation performed by an optical system 101 of the variable focal length lens device 203A to adjust the focus position is the same as operation performed by the optical system 101 of the variable focal length lens device 201A to adjust the focus position. In addition, operation performed by the optical system 101 of the variable focal length lens device 203A to change the magnification m is the same as operation performed by the optical system 101 of the variable focal length lens device 201A to change the magnification m.

Illumination light emitted from the illumination light source 62 is split to the reference optical path 71 and the signal optical path 72a. Illumination light split to the reference optical path 71 passes through the reference optical path 71, and is incident on the light receiving element 53. On the other hand, illumination light split to the signal optical path 72a passes through an optical fiber 61 and the optical system 101 in this order due to an action of the circulator 63. Then, illumination light having passed through the optical system 101 is emitted to an object disposed at a first conjugate point 1. In contrast, illumination light reflected and scattered by the object passes through the optical system 101 and the optical fiber 61 in this order. Then, illumination light having passed through the optical fiber 61 passes through the signal optical path 72b, and is incident on a light receiving element 52 due to an action of the circulator 63. At this time, illumination light incident on the light receiving element 53 from the signal optical path 72b interferes with illumination light incident on the light receiving element 53 from the reference optical path 71. As a result, the variable focal length lens device 203A can obtain interference information about beams of the illumination light from the light receiving element 52 having received two beams of the illumination light.

Note that whereas the variable focal length lens device 203A illustrated in FIGS. 12A and 12B includes the optical system 101, it may include the optical system 103 as illustrated in FIGS. 13A and 13B instead of the optical system 101. FIGS. 13A and 13B is a figure illustrating configuration of the variable focal length lens device 203B according to the third embodiment. The variable focal length lens device 203B includes the optical system 103, the light receiving element 53, the optical fiber 61, the illumination light source 62, the circulator 63, the reference optical path 71, and the signal optical paths 72a and 72b. In addition, whereas the variable focal length lens device 203A includes the optical system 101, it may include the optical system 102 illustrated in FIGS. 2A and 2B or the optical system 104 illustrated in FIGS. 4A and 4B instead of the optical system 101.

In addition, the variable focal length lens devices 203A and 203B include typical interference information processing devices that are necessary for heterodyne detection systems or the like.

In a case where the variable focal length lens devices 203A and 203B are interference information processing devices, for example, the variable focal length lens devices 203A and 203B temporally sweep wavelengths by using wavelength-variable light sources instead of the illumination light source 62, thereby enabling FMCW-scheme distance measurement based on wavelength differences at the time of multiplexing. In this manner, the variable focal length lens devices 203A and 203B which are interference information processing devices are capable of distance measurement on the basis of wavelength differences, and accordingly can obtain interference information also from an object disposed away from the first conjugate point 1.

Note that, within the scope of the present disclosure, the disclosure allows any combinations of embodiments, modifications of any components in embodiments, or omission of any components in embodiments.

### INDUSTRIAL APPLICABILITY

A variable focal length lens device according to the present disclosure is suitable for being used as a variable focal length lens device or the like that has a magnification and a focus position that can be changed as desired, which is suitable for variable focal length lenses.

### REFERENCE SIGNS LIST

1: first conjugate point, 2: second conjugate point, 3: third conjugate point, 11: first variable focal length lens, 21 to 24: second variable focal length lens, 31 to 34: third variable focal length lens, 41: fixed focal length lens, 51: image sensor, 52 and 53: light receiving element, 61: optical fiber, 62: illumination light source, 63: circulator, 71: reference optical path, 72a and 72b: signal optical path, 101 to 104: optical system, 111 to 114: first partial optical system, 121 to 124: second partial optical system, 201A to 201D, 202A, 202B, 203A, and 203B: variable focal length lens device, f1: first focal length, f2: second focal length, f3: third focal length, f4: fourth focal length, d: inter-lens distance

1. A variable focal length lens device comprising:
a first variable focal length lens that has a first focal length;
a second variable focal length lens that is disposed behind the first variable focal length lens, and has a second focal length;
a third variable focal length lens that is disposed behind the second variable focal length lens, and has a third focal length;
a fixed focal length lens that is disposed behind the third variable focal length lens, and has a fourth focal length;
a first conjugate point that is disposed at a distance equal to the first focal length before the first variable focal length lens, and serves as a focus position;
a second conjugate point that is disposed at a distance equal to the fourth focal length behind the fixed focal length lens, and is provided with an image sensor or a light guiding device; and
a third conjugate point disposed at a distance equal to the second focal length behind the second variable focal length lens, and at a distance equal to the third focal length before the third variable focal length lens, wherein
a first partial optical system including the first variable focal length lens and the second variable focal length lens is an infinite conjugate system in relation to the first conjugate point, and
a second partial optical system including the third variable focal length lens and the fixed focal length lens is an infinite conjugate system in relation to the third conjugate point.

2. The variable focal length lens device according to claim 1, further comprising:
an optical path splitter disposed behind the light guiding device;
an illumination light source connected to one end of the optical path splitter; and
a light receiving element connected to another end of the optical path splitter.

3. The variable focal length lens device according to claim 2, further comprising a reference optical path that guides, to the light receiving element, illumination light split from the illumination light source.

4. The variable focal length lens device according to claim 3, wherein the illumination light source is a wavelength-variable light source.
